(19) United States
(12) Patent Application Publication
(10) Pub. No.: US 2007/0284497 A1
(43) Pub. Date: Dec. 13, 2007

(54) Equipment mounting device

(76) Inventors: John Naccarato, Sault St. Marie (CA); Todd Ballard, Vista, CA (US); Sean Watkins, Oceanside, CA (US)

Correspondence Address: Ralph A. Dowell of DOWELL & DOWELL P.C., 2111 Eisenhower Ave, Suite 406, Alexandria, VA, 22314, US

(21) Appl. No.: 11/730,558

(22) Filed: Apr. 2, 2007

Related U.S. Application Data
(60) Provisional application No. 60/787,629, filed on Mar. 31, 2006.
(60) Provisional application No. 60/801,414, filed on May 19, 2006.

(51) Int. Cl. F16L 3/08; A47B 96/06

(52) U.S. Cl. 248/309.1; 248/205.1

(57) ABSTRACT

A mounting device to attach peripheral equipment while operating a bicycle, said mounting device having a base and an aperture in the base to permit a mounting bolt to be inserted, a peripheral wall projecting above the base and defining a receptacle to permit the peripheral equipment to be mounted to the base.

### CROSS-REFERENCE TO RELATED APPLICATIONS

This application claims priority from U.S. Provisional Application No. 60/787,629 filed on Mar. 31, 2006 and U.S. Provisional Application No. 60/801,414 filed on May 19, 2006 which are hereby incorporated by reference.

### FIELD OF THE INVENTION

The present invention relates to an equipment mounting device suitable for cycles.

### SUMMARY OF THE INVENTION

Bicycles and tricycles are used in a variety of applications ranging from basic transportation to recreation and professional sports activities. Bicycles have been utilized as a means of transportation for over a hundred years and continue to grow in popularity. The mountain bike is one type of bike that has become more and more popular in recent years. These types of bikes are often used in rough terrain. The user of the vehicle frequently requires to monitor a device relating to or peripheral to the bicycling activity. For example, it is possible to monitor progress or physical performance through a trip computer or the like, a global positioning system (“GPS”) device, an entertainment device such as an MP3 player, or access to a cell phone or pager may be desirable. In each of these examples, the device being monitored or accessed is independent of the vehicle and therefore must be mounted in some way on the vehicle in a position that facilitates its use.

Typically, devices of this nature may be mounted on the bicycle through the use of a specialized clip that is bolted to a convenient component of the vehicle, such as a handlebar. The mounting devices however tend to be relatively flimsy, add unnecessary weight to the bicycle, can readily be removed thereby increasing the possibility of theft or loss of the equipment, and can unacceptably impede the wind-drag performance of the bicycle. Moreover, the mounting bracket cannot readily be positioned in the most convenient location and may interfere with the operation of other devices such as the brakes or gear operating mechanism.

There is therefore a requirement for a mounting device in which the above disadvantages may be obviated or mitigated.

In general terms, the present invention provides a mounting device that serves as an integrated receptacle or base to hold or attach peripheral equipment while operating a bicycle. The mounting device has a base and an aperture in the base to permit a mounting bolt to be inserted. A peripheral wall projects above the base and defines a receptacle for receiving either an ancillary equipment to be carried or a support to permit the ancillary equipment to be mounted to the base.

In one aspect, the mounting device may also serve as an integral structural retainer which receives a fastener, such as a bolt, which engages the bicycle forks to the bicycle frame and/or handlebar stem, the end of the mounting device being substantially integrated with the bicycle frame. Preferably, the bolt is the stem bolt associated with the handle bar stem and the base includes a recess to accommodate the bolt and the washer typically associated with the bolt.

The mounting device may be manufactured from a variety of materials, including metals such as steel, stainless steel, aluminium, or alloys thereof; ceramics; and polymers. The mounting device may be manufactured from a number of processes, including machining, casting, injection molding, and co-injection molding.

As a further preference, the mounting device includes a clevis to receive a complementary tong on the equipment to be carried.

### BRIEF DESCRIPTION OF THE DRAWINGS

Embodiments of the invention will now be described by way of example only with reference to the accompanying drawings in which:

FIG. 1 is a side view of a portion of a bicycle.

FIG. 2 is a view on the line II-II of FIG. 1.

FIG. 3 is a enlarged view of a portion of the device shown in FIG. 2.

FIG. 4 is a plan view of the device shown in FIG. 3.

FIG. 5 is a view similar to FIG. 3 of an alternative embodiment.

FIG. 6 is a plan view of the embodiment shown in FIG. 5.

FIG. 7 is a view similar to FIG. 5 of a further embodiment.

FIG. 8 is a view similar to FIG. 2 of a further embodiment.

FIG. 9 is a view similar to FIG. 3 of a further embodiment.

FIG. 10 is a view similar to FIG. 3 of a further embodiment.

FIG. 11 is a view similar to FIG. 3 of a further embodiment.

FIG. 12 is a view similar to FIG. 3 of a further embodiment.

FIG. 13 is a view similar to FIG. 3 of a further embodiment.

### DETAILED DESCRIPTION OF THE INVENTION

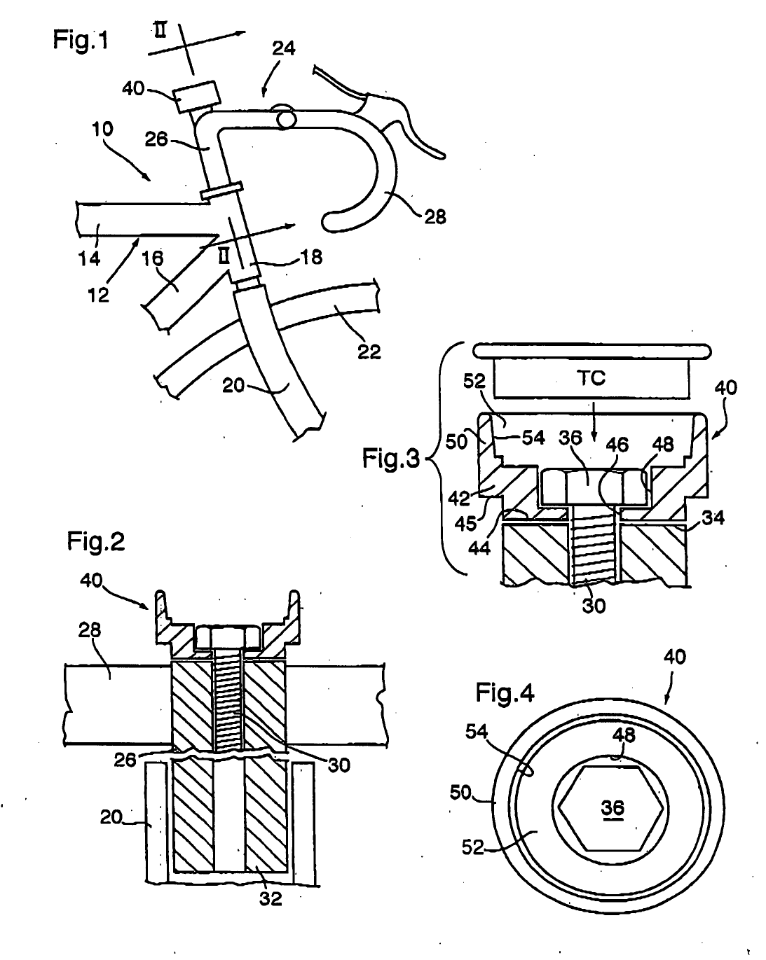

Referring to FIG. 1, a bicycle generally indicated at 10 has a frame 12 including a top tube 14, a bottom tube 16 and a head tube 18. The head tube 18 provides rotational support for a pair of forks 20 that support a front wheel 22. The head tube 18 accommodates a bearing assembly (not shown) that supports an upper end of the fork which, in turn, is connected to a stem 26 of the handlebars assembly 24. The front wheel 22 thus is steered by a handle bar assembly 24 that includes a handle bar stem 26 and handle bars 28.

As can best be seen in FIG. 2, the stem 26 is secured to the forks 20 by a bolt 30 that extends from an upper end face 34 and is threaded in a wedge nut 32. The lower end of the stem 26 and the upper face of the nut 32 are inclined such that tightening of the bolt 30 causes a radial displacement and wedging of the stem within the upper end of the forks 20. It will be appreciated that variations on the locking mechanism may be adopted as is common practice within the bicycle field and that the mechanism shown in exemplary only.

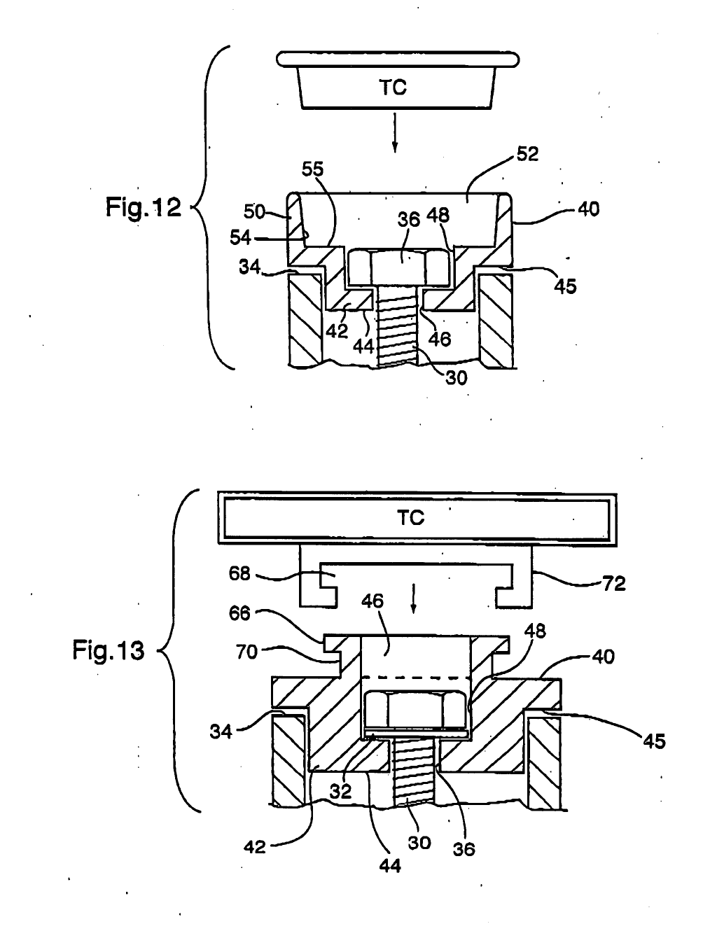

A mounting device 40 is secured to the stem 26 by the bolt 30. The mounting device 40 includes a base 42 having a planar end face 44 and shoulder 45. In the embodiment of FIG. 3, the end face 44 is in abutment with the upper face 34 of the stem 26. Alternatively as shown in the embodiment of FIG. 12, the end face may be recessed within the stem 26 such that the shoulder face 45 is in abutment with the upper face 34 of the stem 26. The shoulder face 45 may be contiguous with the wall of the stem 26 as shown in FIG. 12, or may extend past the wall of the stem 26 as shown in FIG. 3 to receive a peripheral device that is larger than the diameter of the stem 26. In either embodiment, the mounting device has a central aperture 46 to receive the bolt 30. The base 42 has a counter bore 48 to accommodate the head 36 of the bolt 30.

A wall 50 extends from the periphery of the base 42 and projects upwardly to define a recess 52 above the base 42. The recess 52 may be any appropriate shape and has an inner surface 54 that may taper slightly or may have a stepped internal face to present different elevations of the recess 52. The mounting device 40 may be readily secured to the bicycle 10 by removal of the bolt 30 and reinsertion with the bolt through the aperture 46. In the embodiment of FIG. 3, tightening of the bolt 30 brings the end face 44 into abutment with the top face 34 of the stem and thereby securely holds the mounting device 40 in situ. When in situ, the mounting device 40 is centrally located on the handlebars and rotates with the forks 20. Removal of the mounting device 40 requires a socket or driver of the correct size and shape due to the location of the head 36 in the counter bore 48 and thereby provides for a secure engagement of the mounting device 40 to the forks 20 of the bicycle 10.

The device in FIG. 3 may be made from a single material type or, alternatively, the wall 50 may be made from a polymer material that is different than the polymer material used for the base 42, such as produced from co-injection apparatuses and methods for injecting different materials into a single or multi-cavity mold cavity.

The recess 52 is dimensioned to receive an ancillary piece of equipment such as a trip computer indicated as TC in FIG. 3. The trip computer can be cylindrical with an outside diameter similar to that of the recess 52 so that it is securely received within the recess 52 and located against inadvertent displacement. A friction fit is provided between the outer surface of the computer and the inner surface 54 of the recess 52 to inhibit inadvertent removal of the trip computer.

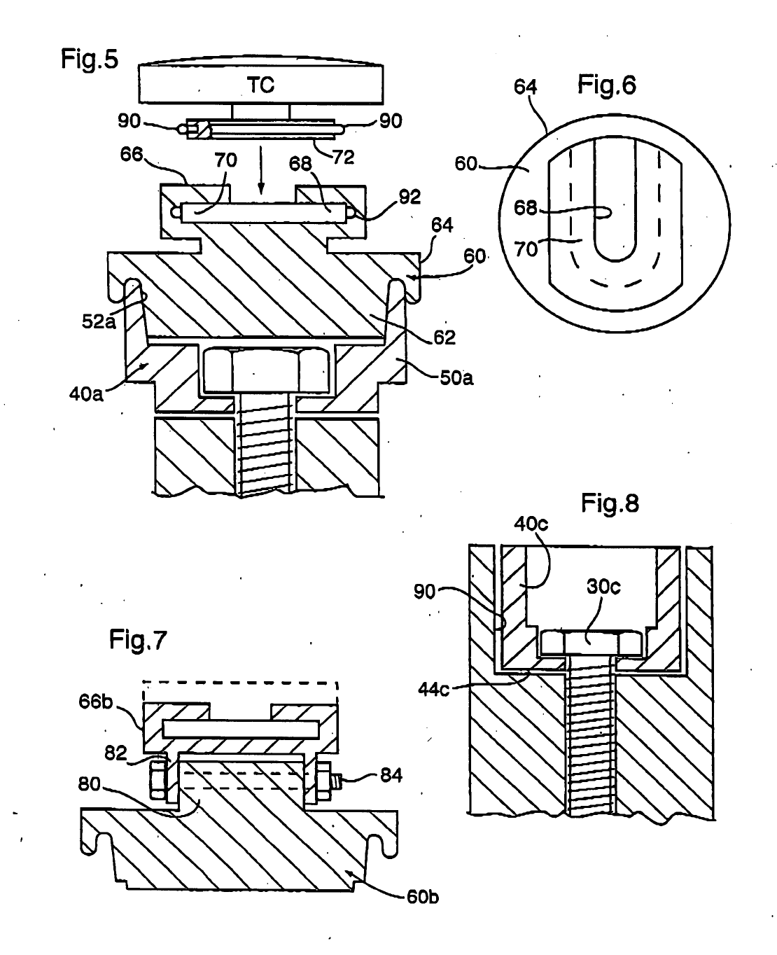

Alternatively, as shown in FIG. 5, in which like reference numerals will be used to denote like components, the recess 52a may be used to receive a complimentary plug 60. The plug 60 has a base conforming to the inner configuration of the recess 52. A clevis 66 is preferably integrally formed with or fixedly coupled to the plug 60. The clevis and plug assembly are also designed to be relatively simple and inexpensive to manufacture and assemble. The clevis 66 is configured and arranged with a mating receiver 72 integrally formed with or fixedly coupled to the trip computer or ancillary equipment to prevent inadvertent release of said trip computer or ancillary equipment from the clevis 66 due to relative movement of the clevis relative to the receiver 72. The clevis may have a slot 68 communicating with a re-entrant channel 70. As can been seen from FIG. 6, the slot 68 and channel 70 are open at one end and closed at the opposite end. The slot 68 and channel 70 are dimensioned to receive a tongue 72A secured to the ancillary component TC. The component TC may be integrally formed with the tongue 72A or the tongue 72A may be secured to the component by adhesive or tape. The tongue 72A is received within the slot 68 and channel 70 so as to be securely located on the plug 60. The tongue may be secured by a friction fit or, as shown in FIG. 5, may have spring loaded balls 90 that engage detents 92 in the slot 68 to inhibit relative movement. The base 62 of the plug in turn is a friction fit within the recess 52a of the bracket 40a and therefore a secure retention of the ancillary equipment TC is obtained.

A further embodiment similar to FIG. 5 is shown in FIG. 7 and like components will be identified with like reference numerals with a suffix “b” added for clarity.

In the arrangement of FIG. 7, the plug 60b has an upstanding pivot block 80. The clevis 66b has a pair of flanges 82 that extend to either side of the block 80. A pivot pin 84 extends through the flanges 80 and block 80 to provide pivotal movement about the axis defined by the pin 84. In this way, the orientation of the clevis 66b may be adjusted to suit the individual needs of the user.

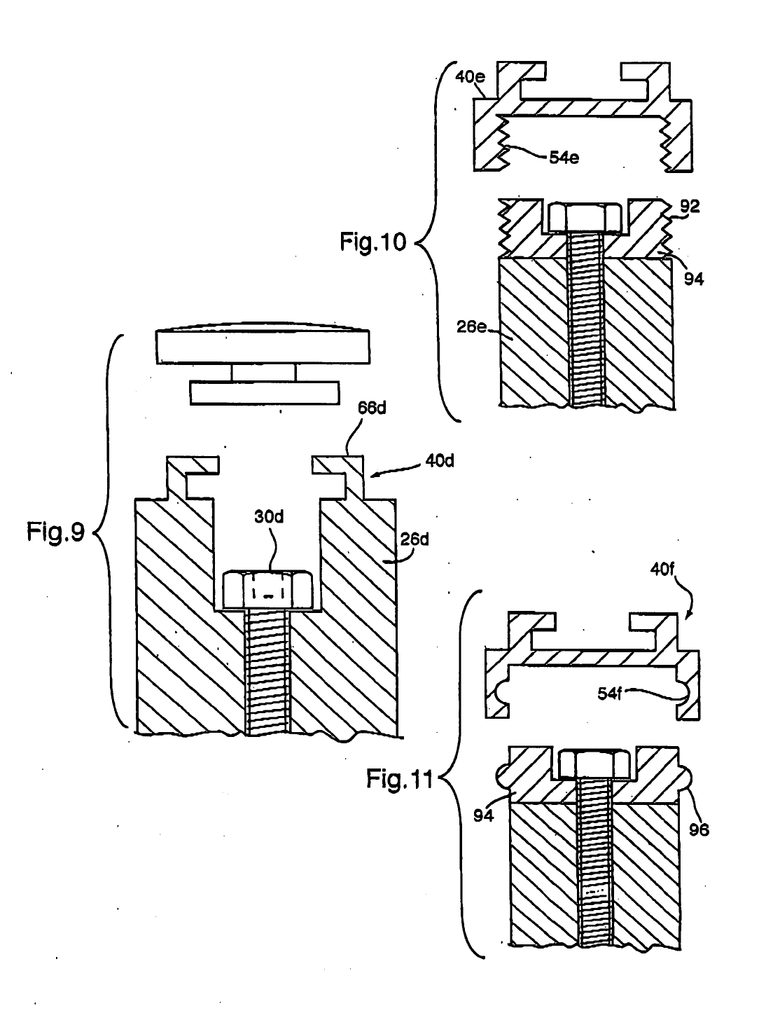

A further embodiment is shown in FIG. 8, in which like numerals with a suffix c will be used to identify like components. In the embodiment of FIG. 8, the stem 26c has a recess 90 formed in its upper surface. The mounting device 40c is located within the recess 90 and secured by the bolt 30c so that the surface 44c is into abutment with the base of the recess 90. By providing a recess 90, the device is integrated in to the overall silhouette of the bicycle and the aerodynamics are preserved.

A further embodiment is shown in FIG. 9 in which like reference numerals will be used to identify like components with a suffix “d” added for clarity. In the embodiment of FIG. 9, the mounting device 40d is integrated with the stem 26d and clevis 66d formed to receive the TC. A central aperture 46d is formed in the integrated stem and mounting to receive the clamping bolt 30d. Preferably, the bolt 30d is a socket drive to minimize the clearance required for the hexagonal wrench key to access the bolt. Although this arrangement requires replacement of the stem 26, it is particularly suitable where long term use of the TC is envisaged.

The arrangements in FIGS. 2 to 8 show the accommodation of the mounting device 40 in an internal cavity. It is also possible, as shown in FIGS. 10 and 11 to mount the device 40 on external surfaces. Thus, in the embodiment of FIG. 10, the device 40e has an internal female thread 54e that engages an external thread 92 provided on a disc 94. The disc is secured by the clamping bolt 30e and provides a rigid mounting point for the device 40e. A locking screw can be provided to prevent unintentional removal.

In the embodiment of FIG. 11, an external rib 96 is provided on the disc 94 to engage a complimentary groove 54f on the device 40f to secure the device. The interference fit is chosen to inhibit accidental removal.

The arrangements shown in FIGS. 10 and 11 could of course be integrated in to the trip computer TC in place of the clevis if required, in which case locking of the thread is not required.

It will be seen therefore that the provision of the mounting device 40 provides a simple yet effective mounting location for ancillary equipment. This may be either directly mounted into the mounting device 40 or may be secured through the use of the mounting plug 60. It will be appreciated that the ancillary component TC may be a trip computer or a cell phone or other device that may be required during use of the vehicle. Where the mounting plug 60 is utilized, the provision of the clevis allows the device to be readily removed and taken with the operator, as may be convenient with a cell phone or pager.

The mounting device may be secured with minimal encumbrance of the normal components of the cycle and does not interfere with its normal operation.

Alternatively, as shown in FIG. 13, in which like reference numerals will be used to denote like components with a suffix g added for clarity, a mounting device 40g is secured to the stem 26g by the bolt 30g, with or without a metal washer 32g. The mounting device 40g includes a base 42g having a planar end face 44g and shoulder face 45g. The end face 44g is in abutment with the upper face 34g of the stem 26g, or as shown, may be recessed within the stem 26g such that the shoulder face 45g is in abutment with the upper face 34g of the stem 26g. The mounting device has a central aperture 46g to receive the bolt 30g. The base 42g has a counter bore 48g to accommodate the head 36g of the bolt 30g. A clevis 66g is preferably integrally formed with or fixedly coupled to the mounting device 40g. The clevis is designed to be relatively simple and inexpensive to manufacture and assemble. The clevis 66g is configured and arranged with a mating receiver 72g integrally formed with or fixedly coupled to the trip computer or ancillary equipment to prevent inadvertent release of said trip computer or ancillary equipment from the clevis 66g due to relative movement of the clevis relative to the receiver 72g. The receiver 72g may have a slot 68g communicating with a re-entrant channel 70g with a friction locking aperture.

The receiver 72g may be secured to the ancillary component as described above, or may be attached to a sleeve or housing configured to receive and hold the ancillary component TC.

It will also be appreciated that in each of the above embodiments the recess may be tilted relative to the axis of the stem 26 to vary the orientation of the ancillary component TC.

What we claim is:

1) A mounting device to attach peripheral equipment while operating a bicycle, said mounting device having a base and an aperture in the base to permit a mounting bolt to be inserted, a peripheral wall projecting above the base and defining a receptacle to permit the peripheral equipment to be mounted to the base.

2) A mounting device according to claim 1 wherein said receptacle is a recess.

3) A mounting device according to claim 1 including a releasable plug engageable with said receptacle to connect said peripheral equipment to said mounting device.

4) A mounting device according to claim 3 wherein said receptacle is a recess and said plug is received in said recess.

5. A mounting device according to claim 3 wherein said plug frictionally engages said receptacle to maintain engagement therewith.

6) A mounting device according to claim 5 wherein said receptacle is a recess and an external surface on said plug frictionally engages and internal surface of said recess.

7. A mounting device according to claim 3 wherein said plug and receptacle have threaded surfaces to connect one to the other.

8) A mounting device according to claim said threaded surface is on an external surface of said peripheral wall.

9) A mounting device according to claim 3 wherein said plug and receptacle are connected by a an interference fit.

10) A mounting device according to claim 3 wherein a clevis is provided on said plug to engage a tongue on said peripheral device.

11) A mounting device according to claim 10 wherein said clevis is adjustable relative to said base.

12. A mounting device according to claim 1 wherein said aperture receives a bolt operable to connect handlebars to forks of a bicycle.

13) A mounting device according to claim 12 wherein said bolt is received in a recess in said base.

14) A mounting device according to claim 12 wherein said base has an end face to be held in abutment with a complementary face on said handlebars by said bolt.

15) A mounting device according to claim 12 wherein said base has a shoulder to be held in abutment with ha complementary face on said handlebars by said bolt.

16) A mounting device according to claim 2 wherein said receptacle includes a clevis integrally formed with said base.

17) A mounting device according to claim 2 wherein said receptacle has a surface to engage frictionally said peripheral equipment.

18) A mounting device according to claim 17 wherein said surface is tapered.

19. A mounting device according to claim 18 wherein said receptacle is a recess and said peripheral equipment is secured within said recess.

20. A mounting device according to claim 2 wherein said receptacle is a recess and said peripheral equipment is secured within said recess.
